(19) United States
(12) Patent Application Publication
(10) Pub. No.: US 2021/0069838 A1
(43) Pub. Date: Mar. 11, 2021

(54) REPAIR/MODIFICATION METHOD FOR METALLIC SUBSTRATES

(71) Applicant: FURUYA METAL CO., LTD., Toshima-ku, Tokyo (JP)

(72) Inventors: Genki ANO, Toshima-ku, Tokyo (JP); Tomohiro MARUKO, Toshima-ku, Tokyo (JP); Tomoaki MIYAZAWA, Toshima-ku, Tokyo (JP); Yuichi IWAMOTO, Toshima-ku, Tokyo (JP)

(21) Appl. No.: 16/965,911

(22) PCT Filed: Jan. 23, 2019
(86) PCT No.: PCT/JP2019/001953

§ 371 Date: Jul. 29, 2020

(30) Foreign Application Priority Data
Feb. 2, 2018 (JP) 2018-017367

(51) Int. Cl. B23P 6/04; B23K 20/12

(52) U.S. Cl. CPC B23P 6/04; B23K 2103/08; B23K 20/1265; B23K 20/1255

(57) ABSTRACT

The repair/modification method for metallic substrates according to the present invention includes: a step for preparing a metallic substrate having a first region that is divided in an in-plane direction of the substrate, the first region containing a defect and/or a structurally discontinuous portion; and a step for repairing the defect and/or modifying the structurally discontinuous portion by pressing a friction tool which does not have a probe against a top surface of the first region while rotating the friction tool so as to generate frictional heat while pressing on the top surface.

### BACKGROUND

### 1. Field of the Disclosure

The present disclosure relates to a method for repairing and/or modifying a structure of metallic substrates, e.g. a method for repairing and/or modifying metallic substrates using a friction tool which does not have a probe (hereinafter also referred to as a probeless tool), in which the maximum depth of a repair part and/or a modification part is formed so as to be no more than 20 mm from a top surface into the interior of the repair part and/or the modification part. Further, in this method, defects present in the interior of a structural body are reduced and regions of interface present in the interior of the structural body are reduced by means of modifying the structure deep into the interior of the structural body while preventing impurities that originate from a probe from being mixed into the interior of the structural body.

### 2. Discussion of the Background Art

When producing a structural body made of a metallic material, there may be casting defects as well as defects originating from melt-bonding, e.g. structurally discontinuous parts such as a blowhole or solidification cracking. These defects and discontinuous parts degrade the mechanical characteristics of the structural body. In addition, a product manufactured using a structural body having defects or structurally discontinuous parts may be negatively affected in terms of quality.

One method for bonding without melting is friction stir welding. In friction stir welding, a tool having a protrusion called a probe is rotated, the probe is inserted into a metallic substrate while being rotated, the resulting frictional heat softens the metallic substrate, and then the metallic substrate is bonded by plastic flow. It is commonly known that a joint formed by friction stir welding is superior in terms of the mechanical characteristics compared to melt-welding because no gas is involved, blowholes are not formed, and the structure is also refined (refer to, for example, Patent Document 1 or Patent Document 2).

Furthermore, thin-plate bonding using a probeless tool has been proposed as one type of friction stir welding, and it has been reported that bonding can be achieved with a thin plate of 0.5 mm to 5 mm (refer to, for example, Patent Document 3).

By utilizing its superior characteristics, friction stir welding has been proposed for application to surface-modifying treatment techniques, such as repairing welding defects and casting defects including blowholes, weld cracking, and the like, as well as structural modification and improving the mechanical characteristics of an execution site (refer to, for example, Patent Document 4). Patent Document 4 discloses a welded joint in which a welded metallic part that has been melt-welded is friction stirred using a probe of a friction stir welding tool.

Patent Document 1: JP2004-090050A

Patent Document 2: JP2014-217836A

Patent Document 3: JP2004-195480A

Patent Document 4: JP2006-239734A

However, several problems arise when using a tool having a probe to perform friction stir welding as described in the techniques of Patent Document 1 or Patent Document 2, or when using a tool having a probe to perform a surface modification treatment as described in the technique of Patent Document 4.

A first problem is that holes, so-called end holes, originating from the probe remain at a bonding terminus. The wall thickness of end hole parts is thin, and the strength of end hole parts is remarkably diminished compared to that of a substrate or a joint, and thus the quality standards of the structural body may not be satisfied.

Methods in which end holes do not remain in a structural body have been proposed, such as a method in which the end hole portion is dispersed to a sacrificial material and then only the end hole part is cut off, and a method in which the probe and the shoulder of the tool are driven separately to perform the bonding. However, in the former, there is a problem of poor material yield, and in the latter, there is a problem in that a specialized device is necessary, and thus these methods result in high costs for production of a structural body using friction stir welding.

A second problem is that the probe is worn down due to friction with the material, and thus the material of the probe is incorporated into the metallic substrate. If elements other than the metallic substrate are mixed into the substrate, the mechanical characteristics of the structural body may change, and this may also have a negative effect on any products obtained using such a structural body.

An example of a product that may be negatively affected is a pressure vessel for single crystal growth. In the case that friction stir welding or a surface modification treatment using a tool having a probe is implemented in the production of a liner or capsule to be accommodated in a pressure vessel, elements other than the substrate which have mixed in may leach into the single crystal growth environment, and this can degrade the quality of the single crystals that are manufactured.

The problems that occur when performing friction stir welding using a tool having a probe may be able to be solved by using the technique of Patent Document 3. However, if bonding is carried out at room temperature using the technique of Patent Document 3, the joint may appear to be securely bonded, but upon examination by the present inventors, it was found that the tensile strength is extremely low compared to the substrate. This is believed to occur because adsorption gas molecules on the abutting surfaces inhibit contact between newly-generated surfaces of the metal. Therefore, Patent Document 3 indicates that it is necessary to carry out a preheating step at 530 to 1600° C.

In fact, in the production of large structural bodies, it is difficult to maintain the parts to be bonded at a high temperature of 500° C. or more, and this is even more difficult with highly-conductive materials (e.g. Cu, Ag, Au, Pt). In addition, compared to a tool having a probe, a probeless tool exhibits weak stirring power, and thus the abutting surfaces must be abutted to each other with high precision. Therefore, larger structural bodies require a higher degree of precision when abutting the parts to be bonded.

### SUMMARY

The present disclosure was created to solve the above-described problems, and an object thereof is to provide a method for repair and/or modification of a structure without allowing any impurities to become mixed in from the top surface to the interior of a structural body. More specifically, the present disclosure provides a repair/modification method for metallic substrates with which defects present in the interior of a structural body can be reduced and regions of interface present in the structural body interior can be reduced by means of modifying the structure deep into the interior of the structural body while preventing impurities originating from a probe on a friction stir welding tool from being mixed into the interior of the structural body.

As a result of diligent examination, the present inventors discovered that the above-described problems can be solved by pressing a friction tool which does not have a probe against a top surface of a metallic substrate at a location to be repaired/modified while rotating the friction tool, so as to generate frictional heat while pressing on the top surface, and thereby the present invention was completed. The repair/modification method for metallic substrates according to the present invention is characterized by including the following: a step for preparing a metallic substrate having a first region that is divided in an in-plane direction of the substrate, the first region containing a defect and/or a structurally discontinuous portion; and a step for repairing the defect and/or modifying the structurally discontinuous portion by pressing a friction tool which does not have a probe against a top surface of the first region while rotating the friction tool so as to generate frictional heat while pressing on the top surface.

In the repair/modification method for metallic substrates according to the present invention encompasses an embodiment the metallic substrate further includes a second region that is divided in the in-plane direction of the substrate, the second region being a portion that does not need to be repaired and/or modified.

In the repair/modification method for metallic substrates according to the present invention encompasses an embodiment a portion up to a maximum depth of 20 mm from the top surface of the metallic substrate is repaired and/or modified.

In the repair/modification method for metallic substrates according to the present invention encompasses an embodiment the metallic substrate has a thickness exceeding 20 mm, and a portion up to a maximum depth of 20 mm from the top surface of the metallic substrate is repaired and/or modified.

In the repair/modification method for metallic substrates according to the present invention encompasses an embodiment the metallic substrate has a thickness of not more than 20 mm, and a portion that is thinner than the entire thickness direction of the metallic substrate or thinner than the substrate thickness from the top surface of the metallic substrate is repaired and/or modified.

In the repair/modification method for metallic substrates according to the present invention, impurities originating from the friction tool preferably do not become mixed in beyond a depth of 1 mm from the top surface of the portion that was repaired and/or modified. By using a probeless tool, impurities originating from the tool can be prevented from being mixed deep into the metallic substrate.

In the repair/modification method for metallic substrates according to the present invention encompasses an embodiment the tensile strength of the substrate including the first region that was repaired and/or modified is 60 to 200% of the tensile strength of the substrate including only the second region.

The repair/modification method for metallic substrates according to the present invention preferably further includes a step for at least partially dissolving the first region before repairing and/or modifying the metallic substrate. This enables the repair/modification to be carried out deep into the metallic substrate.

In the repair/modification method for metallic substrates according to the present invention encompasses an embodiment the first region of the metallic substrate before repair and/or modification has a portion that is welded from the top surface to an underside surface. This enables a melt-bonded part to be repaired/modified.

The repair/modification method for metallic substrates according to the present invention preferably further includes a step for installing or overlaying a material of the same composition as the metallic substrate in at least a portion of the first region of the metallic substrate before repair and/or modification. The thickness of the location that is repaired/modified can be prevented from becoming thinner compared to other locations.

In the repair/modification method for metallic substrates according to the present invention, in the step for repairing and/or modifying, it is preferable to press the friction tool until a portion that is being pressed by the friction tool undergoes plastic deformation. This enables the repair/modification to be carried out deep into the metallic substrate.

In the repair/modification method for metallic substrates according to the present invention, in the step for repairing and/or modifying, relative movement of the friction tool and the metallic substrate is preferably only in a depth direction of the substrate, only in the in-plane direction of the substrate, or in a direction combining the depth direction of the substrate and the in-plane direction of the substrate. This enables the repair/modification to be carried out deep into the metallic substrate.

In the repair/modification method for metallic substrates according to the present invention, it is preferable to complementarily use a heat source other than frictional heat before performing the repair and/or modification or when performing the repair and/or modification. This enables the repair/modification to be carried out deep into the metallic substrate.

In the repair/modification method for metallic substrates according to the present invention encompasses an embodiment the metallic substrate is made of one of Cu, Ag, Au, Pt, a Cu-based alloy, an Ag-based alloy, an Au-based alloy, or a Pt-based alloy.

In the repair/modification method for metallic substrates according to the present invention encompasses an embodiment the friction tool is made of one of an Ir-based alloy, an Ni-based alloy, a Co-based alloy, a hard metal alloy, tool steel, or ceramic.

In the repair/modification method for metallic substrates according to the present invention, the metallic substrate is preferably made of one of Cu, Ag, Au, a Cu-based alloy, an Ag-based alloy, or an Au-based alloy, and the friction tool is preferably made of one of an Ir-based alloy, an Ni-based alloy, a Co-based alloy, a hard metal alloy, tool steel, or ceramic.

In the repair/modification method for metallic substrates according to the present invention, the metallic substrate is preferably made of Pt or a Pt-based alloy, and the friction tool is preferably made of one of an Ir-based alloy, a hard metal alloy, or ceramic.

In the repair/modification method for metallic substrates according to the present invention encompasses an embodiment the metallic substrate constitutes part or all of a liner for a pressure vessel, a capsule for a pressure vessel, a pressure vessel, a sputtering target, or a backing plate for a sputtering target.

### Effects of the Invention

According to the present disclosure, a method can be provided for repair and/or modification of a structure without allowing any impurities to become mixed in from the top surface to the interior of a structural body. More specifically, according to the present disclosure, a repair/modification method for metallic substrates can be provided with which defects present in the interior of a structural body can be reduced and regions of interface present in the structural body interior can be reduced by means of modifying the structure deep into the interior of the structural body while preventing impurities that, for example, originate from a probe on a friction stir welding tool from being mixed into the interior of the structural body.

In addition, the following effects are achieved by the present disclosure. (1) In the part of the structural body that is repaired or modified, the mechanical characteristics and structure are secured equivalent to the substrate. Therefore, the quality reliability of the structural body is high compared to an unrepaired or unmodified structural body. (2) Casting defects of the structural body are repaired, and thus the risk of a quality failure during manufacture is improved. In other words, the manufacturing stability can be increased and costs can be decreased. (3) Since the tool to be used is probeless, the risk of lot-out of the structural body due to probe breakage during repair and/or modification and the risk of impurities originating from the tool being mixed into the interior are extremely small. In addition, since there are no end holes, the yield during manufacture is high. (4) The quality of the structural body is secured due to the repair and/or modification. Therefore, even when manufacturing a structural body using difficult-to-weld materials, no specialized environmental control or pretreatment or precision of the abutting surfaces is necessary, and thus the facilities and steps can be simplified.

### BRIEF DESCRIPTION OF THE DRAWINGS

FIGS. 1(a) and (b) are schematic views illustrating the shape of a friction tool according to an embodiment. FIG. 1(a) is a side surface view, and FIG. 1(b) shows a distal end portion (flat shape) when viewed from the axial direction of the friction tool.

FIGS. 2(a) and (b) are schematic views illustrating the shape of a friction tool according to an embodiment. FIG. 2(a) is a side surface view, and FIG. 2(b) shows a distal end portion (round shape with no corners on distal end side part) when viewed from the axial direction of the friction tool.

FIGS. 3(a) and (b) are schematic views illustrating the shape of a friction tool according to an embodiment. FIG. 3(a) is a side surface view, and FIG. 3(b) shows a distal end portion (shape with spiral cutouts on flat surface) when viewed from the axial direction of the friction tool.

FIGS. 4(a) and (b) are schematic views illustrating the shape of a friction tool according to an embodiment. FIG. 4(a) is a side surface view, and FIG. 4(b) shows a distal end portion (shape with infinite protrusions provided on flat surface) when viewed from the axial direction of the friction tool.

FIG. 5 is a conceptual view one embodiment of a repair/modification method for metallic substrates according to an embodiment.

FIG. 6 is a conceptual view a method of point execution.

FIG. 7 is a conceptual view a method of linear execution.

FIG. 8 is a conceptual view an alternative embodiment of a method of linear execution.

FIG. 9 is a conceptual view an alternative embodiment of a method of linear execution.

FIG. 10 is a conceptual view a method of multiple point execution.

FIG. 11 is a conceptual view an alternative embodiment of a method of multiple point execution.

FIG. 12 is a conceptual view a method of linear execution on a substrate having non-uniform thickness.

FIG. 13 is a schematic view illustrating a method of linear execution on an overlaid substrate.

FIG. 14 illustrates the shape of a cross-section of a beveled substrate of Example 1.

FIG. 15 is a microscopic cross-section image of an overlay welding joint.

FIG. 16 is an enlarged image of the frame portion shown in FIG. 15.

FIG. 17 is a microscopic cross-section image of a repair/modification portion of the overlay welding joint.

FIG. 18 is an enlarged image of the solid-line upper frame portion shown in FIG. 17.

FIG. 19 is an enlarged image of the solid-line lower frame portion shown in FIG. 17.

FIG. 20 is an enlarged image of the dashed-line frame portion shown in FIG. 17.

FIG. 21 is an image showing the results of composition analysis (BEC) corresponding to the dashed-line frame portion shown in FIG. 17.

FIG. 22 is an image showing the results of composition analysis (BEC) corresponding to the dotted-line frame portion shown in FIG. 17.

FIG. 23 shows S-S curves for Example 2 (TIG-FSP), Reference Example 1 (BM), and Comparative Example 1 (TIG).

FIG. 24 shows a comparison of the maximum tensile strength for Example 2 (TIG-FSP), Reference Example 1 (BM), and Comparative Example 1 (TIG).

FIG. 25 shows a comparison of the elongation rate for Example 2 (TIG-FSP), Reference Example 1 (BM), and Comparative Example 1 (TIG).

FIG. 26 is a cross-section image of Example 2 and an enlarged image thereof.

FIG. 27 is a cross-section image of Reference Example 1 and an enlarged image thereof.

FIG. 28 is a cross-section image of Comparative Example 1 and an enlarged image thereof.

FIG. 29 is a cross-section image of a portion in which a material is filled into an end hole, and an enlarged image thereof.

FIG. 30 is a cross-section image of a repaired and modified portion of the portion shown in FIG. 29, and an enlarged image thereof.

FIG. 31 is a cross-section image of an overall repaired/modified portion of Example 4, and an enlarged view thereof.

FIG. 32 is a cross-section image of a substrate used in Example 4.

FIG. 33 is a cross-section image of a TIG overlay welding part before repair/modification of Example 5.

FIG. 34 is a cross-section image of a portion of the TIG overlay welding part of Example 5 that was repaired/modified.

### DETAILED DESCRIPTION OF THE PREFERRED EMBODIMENT

In the following, the present invention shall be described in detail while presenting embodiments, but the present invention should not be interpreted as being limited to such descriptions. Various modifications may be made to the embodiments as long as the effects of the present invention are achieved.

A repair/modification method for metallic substrates according to the present embodiment includes the following: a step (called the “first step”) for preparing a metallic substrate having a first region that is divided in the in-plane direction of the substrate, the first region containing a defect and/or a structurally discontinuous portion; and a step (called the “second step”) for repairing the defect and/or modifying the structurally discontinuous portion by pressing a friction tool which does not have a probe against the top surface of the first region while rotating the friction tool so as to generate frictional heat while pressing on the top surface. In the present embodiment, the metallic substrate further includes a second region that is divided in the in-plane direction of the substrate, and the second region is a portion that does not need to be repaired and/or modified. In the present embodiment, “in-plane direction” indicates any direction in the X-Y plane, where the plane of the substrate top surface is represented using X-Y coordinate axes, and “depth direction” indicates an orientation orthogonal to the in-plane direction. Further, the first region and the second region include the depth direction of the substrate.

(First Step)

The metallic substrate is a substrate made of, for example, one of Cu, Ag, Au, Pt, a Cu-based alloy, an Ag-based alloy, an Au-based alloy, or a Pt-based alloy. Cu-based alloys include, for example, Cu—Zn, Cu—Ni, Cu—Ag, Cu—Sn, and Cu—Sn—P. Ag-based alloys include, for example, Ag—Pd, Ag—Pd—Cu, Ag—Pd—Cu—Ge, Ag—In, and Ag—Sn. Au-based alloys include, for example, ODS (Oxide Dispersion Strengthened)-Au, Au—Pd, Au—Ag, Au—Cu, and Au—Ni. Pt-based alloys include, for example, ODS-Pt, Pt—Rh, Pt—Ir, Pt—Co, and Pt—Cu. The shape of the substrate is, for example, a plate shape, a cylindrical shape, a crucible shape, a capsule shape, an annular shape, etc., but the shape is not limited thereto in the present embodiment. The thickness (wall thickness) of the substrate is not particularly limited, but is, for example, preferably 10 mm or less, and more preferably 5 mm or less. The lower limit of the thickness of the substrate is preferably 1 mm or more. The specific use of the metallic substrate is, for example, as part or all of a liner for a pressure vessel, a capsule for a pressure vessel, a pressure vessel, a sputtering target, or a backing plate for a sputtering target. In the present embodiment, the term “M-based alloy” (M indicates a metallic element such as Cu, Ag, Au, Pt, Ir, Ni, and Co) indicates an alloy in which M is the element having the largest content (% by mass) among the elements that constitute the alloy, and preferably indicates an alloy in which the content of M is 50% by mass or more. For example, in an Ag-based alloy, Ag is preferably 95% by mass or more. In a Cu-based alloy, Cu is preferably 50% by mass or more.

The repair and/or modification is performed on an exposed surface of the metallic substrate, i.e. on either one of the top surface and the underside surface, or on both the top surface and the underside surface. With regard to the end surface of the substrate, although it also depends on the width of the end surface (in a plate material, this width corresponds to the wall thickness), the end surface of the substrate does not need to be repaired and/or modified if it is 40 mm or less. Metallic substrates are broadly classified into cases in which repair and/or modification must be performed over the entire in-plane direction of the substrate, and cases in which repair and/or modification must be performed on a portion of the in-plane direction of the substrate. In the present embodiment, the portion which must be repaired and/or modified is expressed as a first region, and the portion which does not need to be repaired and/or modified is expressed as a second region. In other words, metallic substrates include embodiments having only a first region that is divided in the in-plane direction of the substrate, as well as embodiments having a first region and a second region that are divided in the in-plane direction of the substrate.

In the present embodiment, repair indicates the removal or reduction of defects originating from melt-bonding such as a blowhole or solidification cracking, or structurally discontinuous parts such as casting defects in the case that such defects or structurally discontinuous parts exist or may exist in a metallic substrate. Further, modification indicates the elimination of molten structures or dendrites, making crystal grains equi-axial, micronizing crystal grains, and the like. The present embodiment also includes cases in which repair and modification are carried out simultaneously. In the present specification, “repair and/or modification” may be written as “repair/modification”.

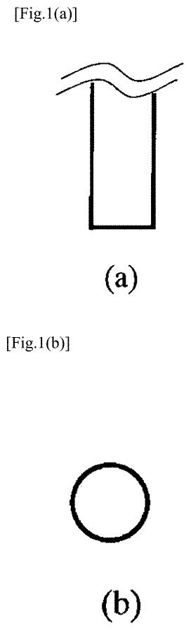

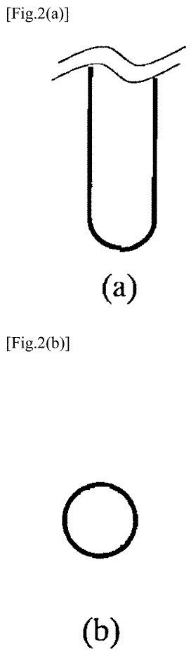

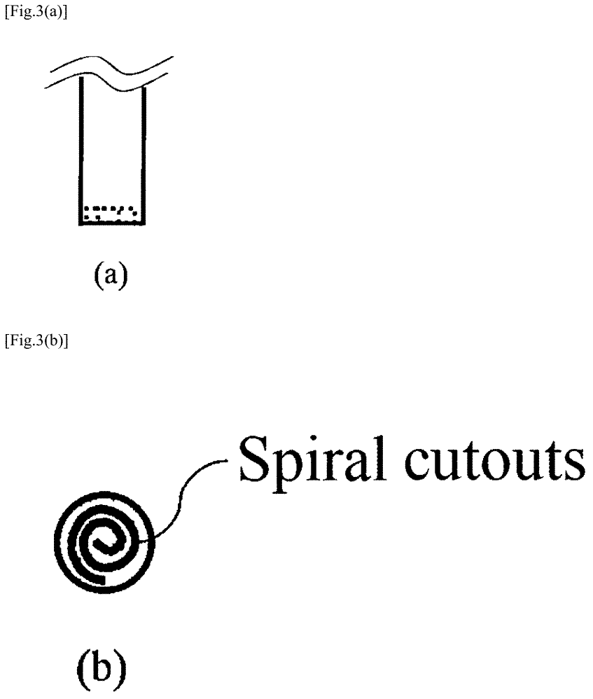

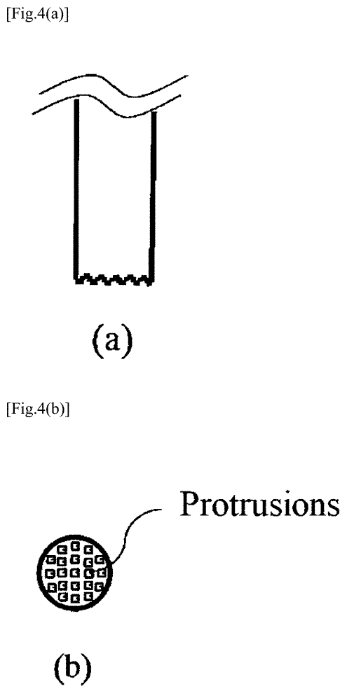

The friction tool is made of, for example, one of an Ir-based alloy, an Ni-based alloy, a Co-based alloy, a hard metal alloy, tool steel, or ceramic. Ir-based alloys include, for example, Ir—Re, Ir—Re—Zr, Ir—Hf, and Ir—Zr. Ni-based alloys include, for example, Ni—Ir, Ni—Ir—Al—W, and Ni—Al—V. Co-based alloys include, for example, Co—Cr, Co—Mo, Co—W, Co—Cr—Ru, and Co—Al—W. Ceramic includes, for example, PCBN, Ti—C, Ti—N, and Si—N. Hard metal alloys include, for example, W—C, W—Re, W—C—Co, and W—C—Ni. Tool steel includes, for example, SK, SKD, SKH, and SKS. In the present embodiment, a friction tool which does not have a probe is used as the friction tool. A friction tool which does not have a probe has, for example, the shapes shown in FIGS. 1 to 4. Herein, a friction tool 5 is rod-shaped, and the distal end portion thereof is not equipped with a probe pin that is used in a friction stir welding method. The distal end portion may have the shape shown in FIG. 1 (flat shape) or FIG. 2 (rounded shape), but the distal end portion preferably is a rough surface having a plurality of recesses/protrusions. Although it also depends on the operation of the friction tool, there may be conceived examples of a grounding surface having the shape with spiral cutouts shown in FIG. 3 or the shape having infinite protrusions shown in FIG. 4. By using the shape shown in FIG. 3, the material that causes plastic flow to occur can be gathered together on the shaft of the friction tool so as to promote plastic flow. Further, using the shape shown in FIG. 4 leads to a decrease in the pressing of the friction tool.

(Second Step)

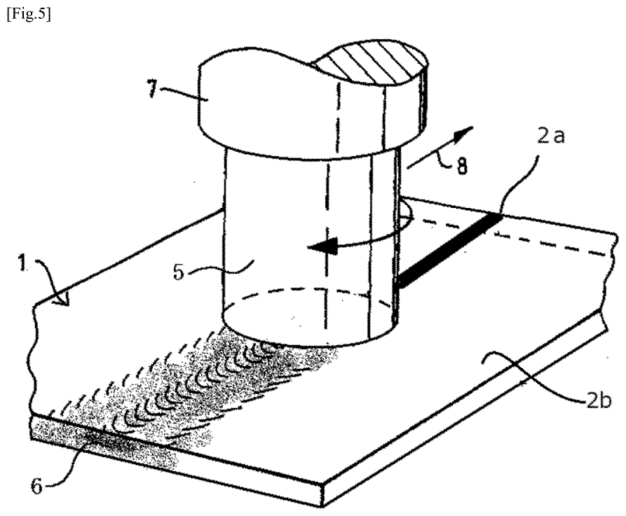

The second step will be explained referring to FIG. 5. A metallic substrate 1 has a first region 2a and a second region 2b. The first region 2a is, for example, a portion in which melt-welding has been performed. The second region 2b is a portion other than that in which melt-welding has been performed, i.e. a normal substrate portion in which repair/modification is not needed. In the second step, the friction tool 5 which does not have a probe is pressed against the top surface of the first region 2a while being rotated by a motor 7 so as to generate frictional heat while pressing on the top surface of the first region 2a, and thereby a defect is repaired and/or a structurally discontinuous portion is modified. The present embodiment includes first rotating the friction tool 5 and then pressing it against the top surface of the first region 2a, or pressing the friction tool 5 against the top surface of the first region 2a without rotating the friction tool 5, and then initiating the rotation of the friction tool 5. FIG. 5 shows an embodiment (linear execution) in which the friction tool 5 is moved in a direction 8 along the first region 2a while being rotated. The friction tool 5 is pressed against the top surface, and after plastic flow has occurred due to the rotational operation, solidification occurs. In the present embodiment as shown in FIG. 5, the width of a solidification portion 6 at which plastic flow has occurred (solidification portion after formation of a plastic region) is approximately equal to the diameter of the tool.

Various executions are possible by changing the insertion direction, execution direction, and movement direction of the friction tool 5 relative to the metallic substrate 1. Herein, the insertion direction indicates the direction in which the friction tool 5 is pressed against the substrate, the execution direction indicates the direction in which the friction tool 5 moves in a state of being in contact with and/or pressing against the substrate, and the movement direction indicates the direction in which the friction tool 5 moves in a state in which it is not being pressed.

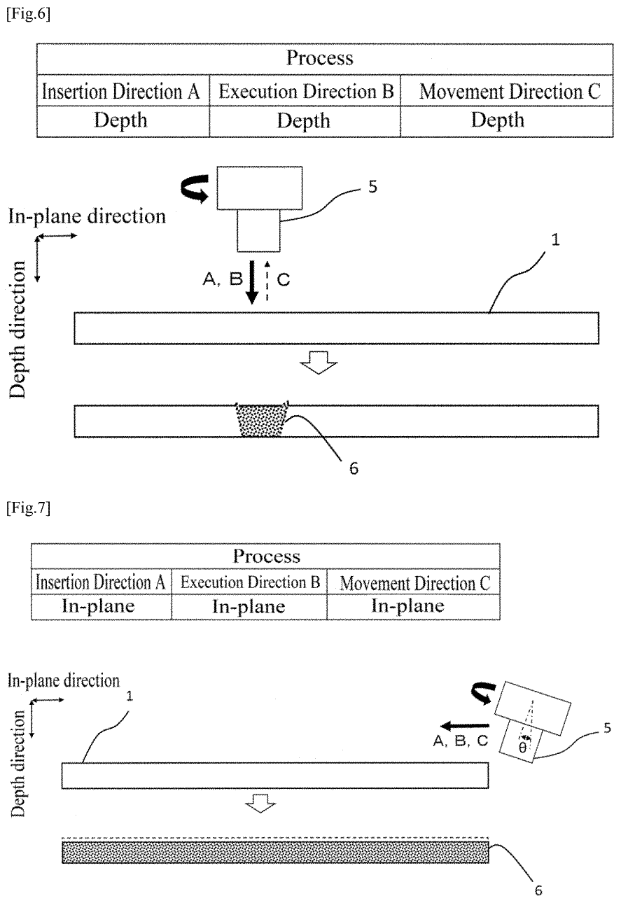

FIG. 6 illustrates a method of point execution. As shown in FIG. 6, in the second step, the friction tool 5 is pressed until the portion that is being pressed by the friction tool 5 undergoes plastic deformation. An insertion direction A of the friction tool 5 is the depth direction relative to the substrate, and an execution direction B is also the depth direction. A movement direction C of the friction tool 5 is the direction in which the friction tool 5 is separated from the substrate after execution. Due to this configuration, point execution is carried out in about the same size as the distal end part of the friction tool 5. If the amount of movement in the depth direction, which is the execution direction B, of the friction tool 5 is increased, the pressing force increases, and the depth of the solidification portion 6 at which plastic flow has occurred increases.

FIG. 7 illustrates a method of linear execution. As shown in FIG. 7, in the second step, the relative movement of the friction tool 5 and the metallic substrate 1 is only in the in-plane direction of the substrate. The friction tool 5 is initially separated from an end part of the metallic substrate 1 in the in-plane direction, and set at position where the pressing force will be exerted when the friction tool 5 is brought into contact with the top surface of the metallic substrate 1. The friction tool 5 is then moved only in the in-plane direction. The portion that is being pressed by the friction tool 5 undergoes plastic deformation in accordance with the movement of the friction tool 5. The insertion direction A, the execution direction B, and the movement direction C of the friction tool 5 are all the in-plane direction with respect to the substrate. Due to this configuration, a linear execution in a width about the same as that of the distal end part of the friction tool 5 is carried out from end to end of the substrate. By setting the friction tool 5 at a position (a deeper position) at which the pressing force is more strongly exerted on the metallic substrate 1, the pressing force increases and the depth of the solidification portion 6 at which plastic flow has occurred also increases. Execution over a broader region can be performed by repeating the linear execution in parallel lines, and thus, for example, the entire surface of the substrate can be repaired and/or modified.

As shown in FIG. 7, by tilting the friction tool 5 by θ° relative to the metallic substrate 1 so that the distal end of the friction tool 5 is preceding with respect to the execution direction, the friction tool 5 can be moved more smoothly in the in-plane direction while pressing the substrate. θ is preferably 1 to 45°, and more preferably 1 to 5°.

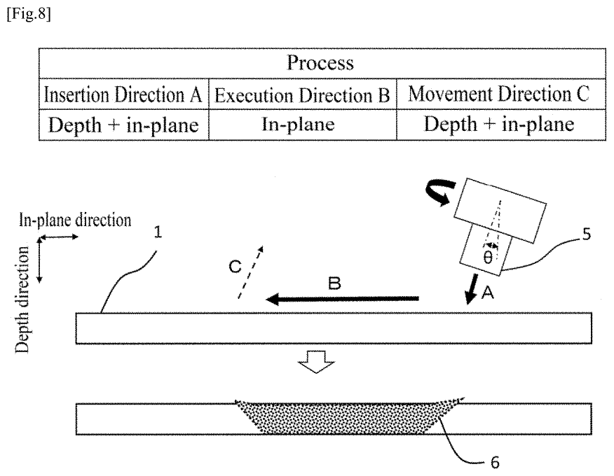

FIG. 8 illustrates a method of linear execution. As shown in FIG. 8, in the second step, the relative movement of the friction tool 5 and the metallic substrate 1 is in the in-plane direction of the substrate and in a direction combining the depth direction of the substrate and the in-plane direction of the substrate. Since the friction tool 5 is tilted by θ° and moved in the rotation axis direction of the tool, the insertion direction A of the friction tool 5 has vector components of both the depth direction and the in-plane direction. Since the insertion direction A has a vector component of the depth direction, the friction tool 5 presses on the metallic substrate 1. The friction tool 5 is moved in the in-plane direction while pressing on the substrate. In other words, the execution direction B is the in-plane direction. Subsequently, the friction tool 5 is moved in a direction opposite the insertion direction A so as to separate the friction tool 5 from the substrate. In other words, the movement direction C has vectors of both the depth direction and the in-plane direction. Due to this configuration, a linear execution in a width about the same as that of the distal end part of the friction tool 5 is carried out on a portion of the top surface of the substrate. Execution over a broader region can be performed by repeating the linear execution in parallel lines.

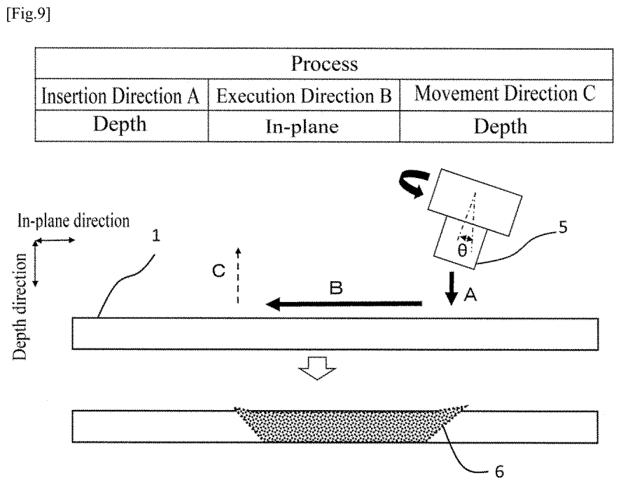

FIG. 9 illustrates a method of linear execution. FIG. 9 is an alternative embodiment of FIG. 8. As shown in FIG. 9, in the second step, the relative movement of the friction tool 5 and the metallic substrate 1 is in the in-plane direction of the substrate and in the depth direction of the substrate. Since the friction tool 5 is tilted by θ° and the friction tool 5 is moved vertically downward, the insertion direction A of the friction tool 5 has a vector component of only the depth direction. Since the insertion direction A has a vector component of the depth direction, the friction tool 5 presses on the metallic substrate 1. The friction tool 5 is moved in the in-plane direction while pressing on the substrate. In other words, the execution direction B is the in-plane direction. Subsequently, the friction tool 5 is moved vertically upward so as to separate the friction tool 5 from the substrate. In other words, the movement direction C has a vector component of the depth direction. Due to this configuration, a linear execution in a width about the same as that of the distal end part of the friction tool 5 is carried out on a portion of the top surface of the substrate. Execution over a broader region can be performed by repeating the linear execution in parallel lines.

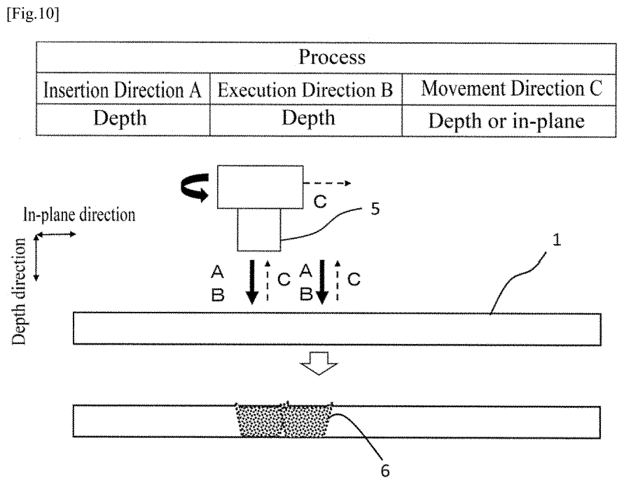

FIG. 10 illustrates a method of multiple point execution. FIG. 10 is an alternative embodiment of FIG. 6. As shown in FIG. 10, in the second step, the friction tool 5 is pressed until the portion that is being pressed by the friction tool 5 undergoes plastic deformation. The insertion direction A of the friction tool 5 is the depth direction relative to the substrate, and the execution direction B is also the depth direction. The movement direction C of the friction tool 5 is the original direction after the friction tool 5 is pressed, i.e. vertically upward movement. Due to this configuration, point execution is carried out in about the same size as the distal end part of the friction tool 5. Next, the friction tool 5 is moved in the in-plane direction of the substrate, and then point execution is carried out again in the same manner. The solidification portion 6 at which plastic flow has occurred becomes an aggregate of the multiple point executions. By changing the amount of movement in the depth direction, which is the execution direction B, of the friction tool 5 according to each point execution, the depth of the solidification portion 6 at which plastic flow has occurred can be changed for each point execution.

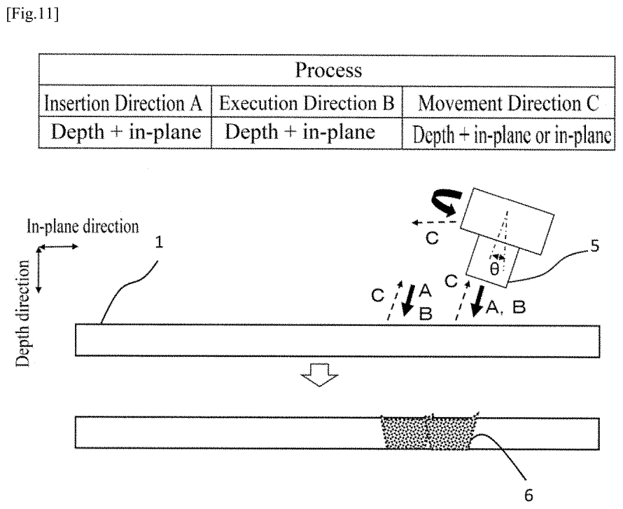

FIG. 11 illustrates a method of multiple point execution. FIG. 11 is an alternative embodiment of FIG. 10. As shown in FIG. 11, in the second step, the friction tool 5 is pressed until the portion that is being pressed by the friction tool 5 undergoes plastic deformation. Specifically, the insertion direction A and the execution direction B of the friction tool 5 are a direction combining the depth direction of the substrate and the in-plane direction of the substrate. Since the friction tool 5 is tilted by θ° and moved in the rotation axis direction of the tool, the insertion direction A and the execution direction B of the friction tool 5 have vector components of both the depth direction and the in-plane direction. Since the insertion direction A and the execution direction B have a vector component of the depth direction, the friction tool 5 presses on the metallic substrate 1. After the friction tool 5 has been pressed, the friction tool 5 is moved as is in the original direction as the movement direction C so as to separate the friction tool 5 from the substrate. The movement direction C has a vector component of the direction combining the depth direction of the substrate and the in-plane direction of the substrate. Due to this configuration, point execution is carried out in about the same size as the distal end part of the friction tool 5. Next, the friction tool 5 is shifted in the in-plane direction of the substrate, which serves as the movement direction C, and then point execution is carried out again in the same manner. The solidification portion 6 at which plastic flow has occurred becomes an aggregate of the multiple point executions. By changing the vector component of the depth direction, which is the execution direction B, of the friction tool 5 according to each point execution, the depth of the solidification portion 6 at which plastic flow has occurred can be changed for each point execution.

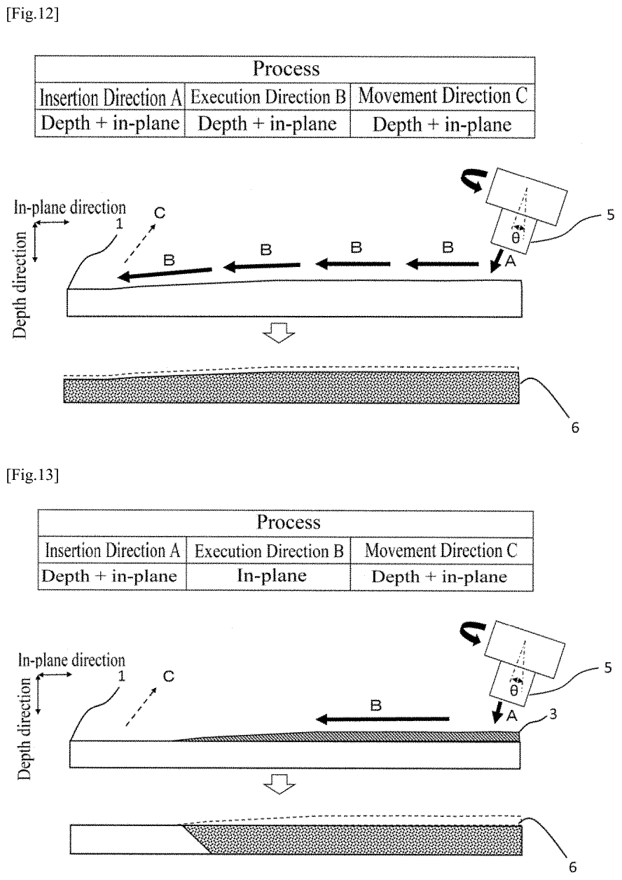

FIG. 12 illustrates a method of linear execution on a substrate having non-uniform thickness. As shown in FIG. 12, in the second step, the relative movement of the friction tool 5 and the metallic substrate 1 is in a direction combining the depth direction of the substrate and the in-plane direction of the substrate. Since the friction tool 5 is tilted by θ° and moved in the rotation axis direction of the tool, the insertion direction A of the friction tool 5 has vector components of both the depth direction and the in-plane direction. Since the insertion direction A has a vector component of the depth direction, the friction tool 5 presses on the metallic substrate 1. The friction tool 5 is moved along the top surface of the substrate while pressing on the substrate. In other words, the execution direction B is a direction combining the depth direction of the substrate and the in-plane direction of the substrate. At this time, the vector component of the depth direction of the substrate is adjusted so that the positional relationship between the distal end part of the friction tool 5 and the top surface of the metallic substrate 1 stays constant. Subsequently, the friction tool 5 is moved in a direction opposite the insertion direction A. In other words, the movement direction C has vector components of the both depth direction and the in-plane direction. Due to this configuration, a linear execution in a width about the same as that of the distal end part of the friction tool 5 is carried out on a portion of the top surface of the substrate. Execution over a broader region can be performed by repeating the linear execution in parallel lines. A smoother execution can be achieved by synchronizing θ so that the angle formed by the tilt of the axis of the friction tool 5 and the top surface of the metallic substrate 1 stays constant during execution.

The present embodiment preferably further includes a step (third step) for installing or overlaying a material of the same composition as the metallic substrate in at least a portion of the first region of the metallic substrate before repair and/or modification. In the present embodiment, since the metallic substrate is pressed by the friction tool, the thickness of the substrate becomes thinner after the repair and modification has been performed. Thus, thinning of the substrate can be prevented by providing the third step.

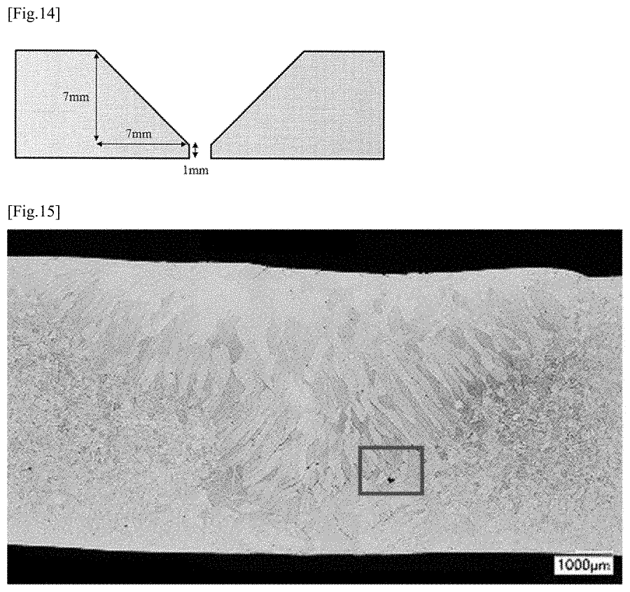

FIG. 13 illustrates a method of linear execution on an overlaid substrate. As shown in FIG. 13, in the second step, the relative movement of the friction tool 5 and the metallic substrate 1 is in a direction combining the depth direction of the substrate and the in-plane direction of the substrate. Since the friction tool 5 is tilted by θ° and moved in the rotation axis direction of the tool, the insertion direction A of the friction tool 5 has vector components of both the depth direction and the in-plane direction. Since the insertion direction A has a vector component of the depth direction, the friction tool 5 presses on an overlaying 3 on the metallic substrate 1. At this time, the vector component of the depth direction of the substrate is adjusted so that the substrate thickness ultimately reaches the original thickness of the substrate. The friction tool 5 is moved in the in-plane direction of the substrate while pressing on the substrate. In other words, the execution direction B is the in-plane direction of the substrate. Subsequently, the friction tool 5 is moved in a direction opposite the insertion direction A. In other words, the movement direction C has vector components of the both depth direction and the in-plane direction. Due to this configuration, a linear execution in a width about the same as that of the distal end part of the friction tool 5 is carried out on a portion of the top surface of the substrate, and the substrate is processed so as to return to the original thickness. In the method of FIG. 13, it is not necessary to perform the pressing until the original substrate depth has been reached in a single execution, and the process may be carried out over multiple executions at the same location until the substrate thickness returns to the original substrate thickness. Execution over a broader region can be performed by repeating the linear execution in parallel lines.

Similar to FIG. 7, as shown in FIGS. 8, 9, 11, 12, and 13, the friction tool 5 is tilted by θ° relative to the metallic substrate 1, and thereby a smoother execution can be carried out while generating plastic flow in the depth direction.

In a structural body produced using the method of the present embodiment, casting defects present in a part to be repaired or a part to be modified, defects originating from melt-bonding, and structurally discontinuous parts are reduced due to the effects of the repair and/or modification. In this way, origin points of breakage are reduced, and thus the mechanical characteristics are secured equivalent to the substrate. For example, comparing a case in which a structural body to be used in a high-temperature, high-pressure environment is produced by melt-welding and a case in which a melt-bonded joint is repaired or modified using a probeless tool, the joint of the structural body in the latter case exhibits superior mechanical characteristics. In other words, the structural body has high reliability. Specifically, in the present embodiment, the tensile strength of the substrate including the first region that was repaired and/or modified is 60 to 200% of the tensile strength of the substrate including only the second region, and preferably 80 to 150%.

Further, since a probeless tool is used for the repair and/or modification, no end holes remain after execution, and the mixing in of impurities originating from the probeless tool can be suppressed to within 1 mm from the top surface of the repaired part and/or the modified part. In other words, impurities originating from the friction tool do not become mixed beyond the 1 mm from the top surface of the portion that was repaired and/or modified. Even if impurities originating from the probeless tool do become mixed in, the impurities would be present at a shallow position from the top surface of the repaired part or modified part, and thus removal thereof by outer surface cutting or polishing, etc. is easy, and any negative effects on the product manufactured using the structural body can be reduced.

The present embodiment may further include a step (fourth step) for at least partially dissolving the first region before repairing and/or modifying the metallic substrate. Further, in the present embodiment, there may be a portion that is welded from the top surface to the underside surface in the first region of the metallic substrate before performing repair and/or modification. Since the mechanical characteristics of the part to be repaired or the part to be modified of the structural body are secured by performing the repair and/or modification step using a probeless tool, there is an advantage in that the first region may be partially dissolved or melt-welded before the repair and/or modification. Therefore, the dissolving conditions and environment, the abutting precision of a bonded part, and the size and amount of interior defects, which must be controlled during the manufacture of the structural body, can be relaxed. Thus, the facilities can be simplified, and the product can be stably supplied.

In the present embodiment, it is preferable to complementarily use a heat source other than frictional heat before performing the repair and/or modification or when performing the repair and/or modification. The heat source other than frictional heat can be, for example, heating with a burner or heating by energization heat generation. This enables the depth of the solidification portion at which plastic flow has occurred to be increased.

In the present embodiment, a portion up to a maximum depth of 20 mm from the top surface of the metallic substrate can be repaired and/or modified. If the metallic substrate has a thickness exceeding 20 mm, a portion up to a maximum depth of 20 mm from the top surface of the metallic substrate can be repaired and/or modified. If the metallic substrate has a thickness of 20 mm or less, a portion that is thinner than the entire thickness direction of the metallic substrate or thinner than the substrate thickness from the top surface of the metallic substrate can be repaired and/or modified. If the method of the present embodiment is applied from both surfaces of the metallic substrate, repair/modification can be performed up to a thickness of 40 mm.

In the present embodiment, especially good repair/modification can be achieved when the metallic substrate is made of one of Cu, Ag, Au, a Cu-based alloy, an Ag-based alloy, or an Au-based alloy and the friction tool is made of one of an Ir-based alloy, an Ni-based alloy, a Co-based alloy, a hard metal alloy, tool steel, or ceramic.

In the present embodiment, especially good repair/modification can be achieved when the metallic substrate is made of Pt or a Pt-based alloy and the friction tool is made of one of an Ir-based alloy, a hard metal alloy, or ceramic.

### EXAMPLES

In the following, the present invention will be explained in further detail while presenting examples, but the present invention should not be interpreted as being limited to such examples.

### Example 1

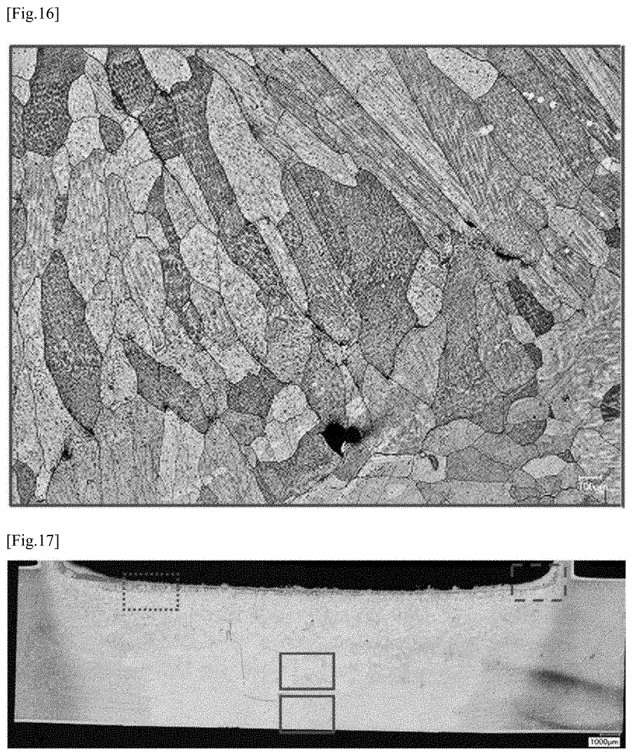

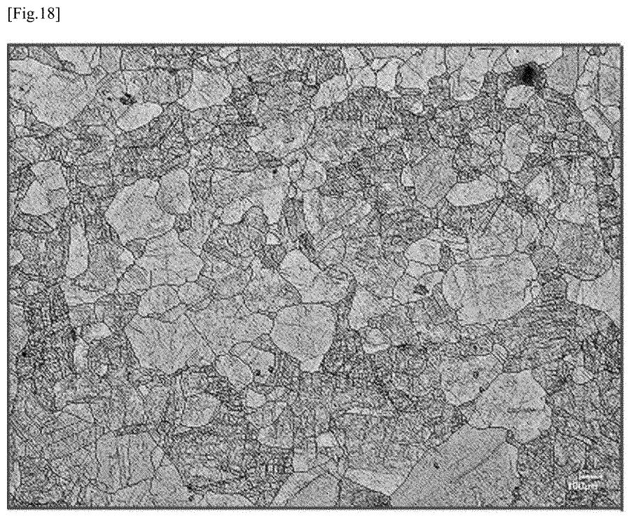

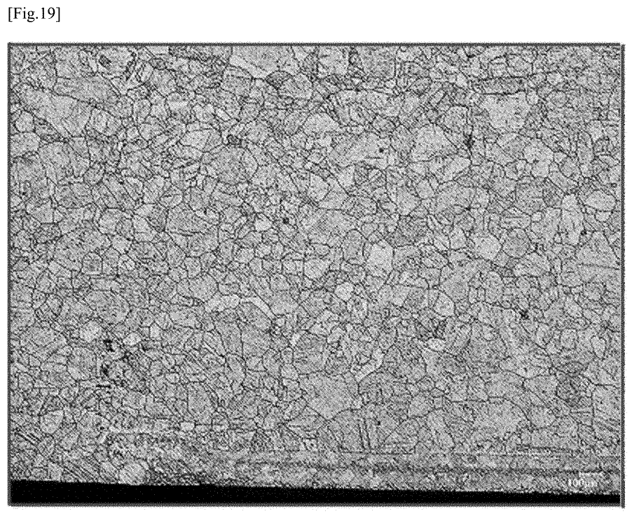

Two plate-shaped substrates made of an Ag-based alloy (composition of Ag—Pd—Cu—Ge) and measuring 100 mm×50 mm×8 mm in thickness were prepared. The substrates were beveled so that the cross-section thereof has the shape shown in FIG. 14. Subsequently, the substrates were overlaid and welded with an Ag-based alloy of the same composition to produce an Ag-based alloy joint. FIG. 15 is a microscopic cross-section image of this overlay welding joint. FIG. 16 is an enlarged image of the frame portion shown in FIG. 15. According to this enlarged image, molten structures, dendrites, and blow holes were able to be confirmed. Next, substrate repair and/or modification was carried out by executing the process shown in FIG. 8 using a friction tool that is made of an Ir-based alloy (composition of Ir—Re—Zr), that has a diameter of 25 mm, and that has a distal end with a flat shape, under conditions in which the tilt angle θ was 3°, a silicon nitride plate was used as a backing plate, argon gas serving as a shield gas was flowed at 25 L/min, the tool rotation speed was 3000 rpm, the tool movement speed was 10 mm/min, and the tool insertion amount was 1.7 mm. Under the conditions presented in Example 1, the amount of heat during execution is high and the modification depth is large. At the same time, these conditions are severe for the friction tool. FIG. 17 is a microscopic cross-section image of a repair/modification portion of the overlay welding joint. FIG. 18 is an enlarged image of the solid-line upper frame portion shown in FIG. 17. FIG. 19 is an enlarged image of the solid-line lower frame portion shown in FIG. 17. Upon comparing FIG. 16 with FIGS. 18 and 19, it was confirmed that in FIGS. 18 and 19, the molten structures and dendrites were eliminated, the crystal grains were micronized, and the blow holes were reduced.

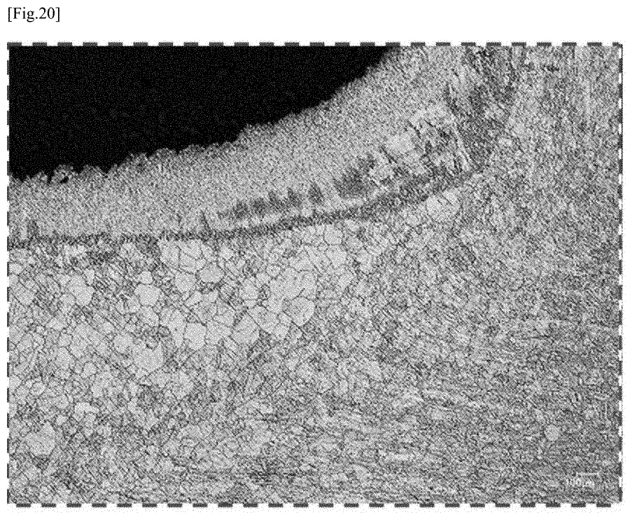

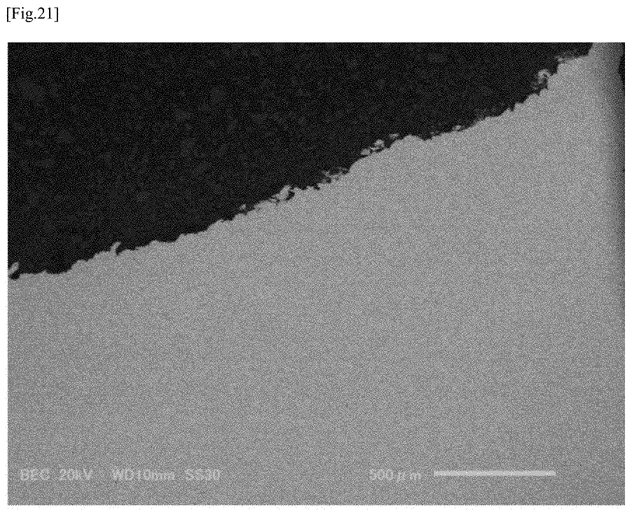

FIG. 20 is an enlarged image of the dashed-line frame portion shown in FIG. 17. FIG. 21 shows the results of composition analysis (BEC, Backscattered Electron Composition) corresponding to the dashed-line frame portion shown in FIG. 17. According to FIG. 21, mixing in of impurities originating from the friction tool could not be confirmed.

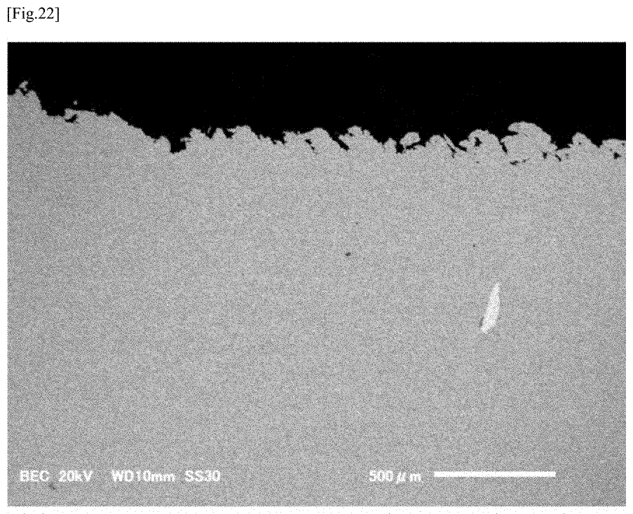

FIG. 22 shows an image of the results of composition analysis (BEC) of the dotted-line frame portion shown in FIG. 17. A single broken piece of iridium (length of 200 μm, width of 50 μm) was discovered as a material other than the substrate at a depth of 500 μm from the top surface of the execution part. This iridium is believed to be an impurity originating from the friction tool. Since a probeless friction tool was used, it was confirmed that even if impurities were mixed in, such impurities were within a depth of 1 mm from the top surface.

### Example 2

A plate material made of pure Ag (purity of 99.99%) with a thickness of 2.2 mm was prepared and subjected to TIG (Tungsten Inert Gas) welding, and then repair/modification of the TIG part was carried out by executing the process shown in FIG. 8. The plate material before cutting off a test piece was heat treated in atmosphere for 2 hours at 400° C. so as to eliminate any effects of distortion originating from the welding or repair/modification. The test piece, for which the tensile strength was confirmed, was molded, utilizing the 14B standard of JIS Z2241, to a uniform thickness of 2 mm using a wire cutting device so that there was no unevenness in the thickness between reference points. Further, a friction tool that is made of an Ir-based alloy (composition of Ir—Re—Zr), that has a diameter of 15 mm, and that has a distal end with a flat shape was used for the repair/modification of the TIG part, under conditions in which the tilt angle θ was 3°, a silicon nitride plate was used as a backing plate, argon gas serving as a shield gas was flowed at 25 L/min, the tool rotation speed was 3000 rpm, the tool movement speed was 100 mm/min, and the tool insertion amount was 0.4 mm.

### Reference Example 1

Similar to Example 2, a plate material made of pure Ag with a thickness of 2.2 mm was prepared, and then a test piece was molded using the same procedure as in Example 2 without performing TIG welding and without carrying out repair/modification.

### Comparative Example 1

Similar to Example 2, a plate material made of pure Ag with a thickness of 2.2 mm was prepared and then subjected to TIG welding, and then a test piece was molded using the same procedure as in Example 2 without carrying out repair/modification of the welded part.

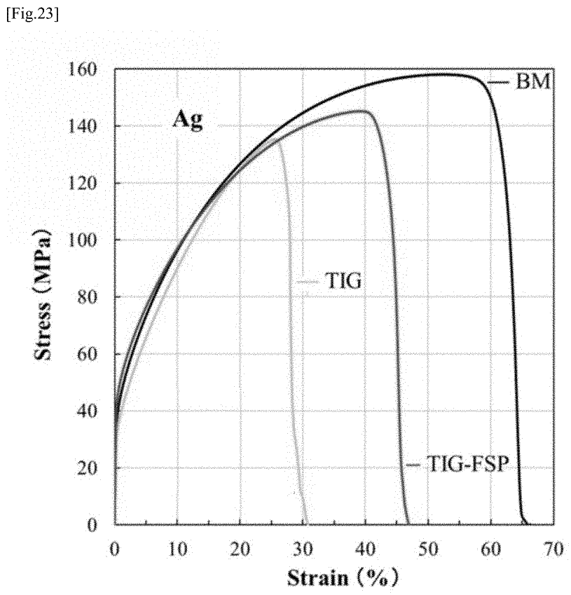

FIG. 23 shows S-S curves for Example 2, Reference Example 1, and Comparative Example 1. In FIG. 23, TIG-FSP indicates a sample of Example 2 in which TIG welding was performed and then the repair/modification of the present invention was carried out, BM indicates the base material of Reference Example 1, and TIG indicates a sample of Comparative Example 1 in which only TIG welding was performed.

As the tester, a universal tester made by Instron (model 5582, load cell 10 kN) was used, and reference was made to JIS Z2241:2011 “Metallic Material Tensile Test Method” for the measurement method.

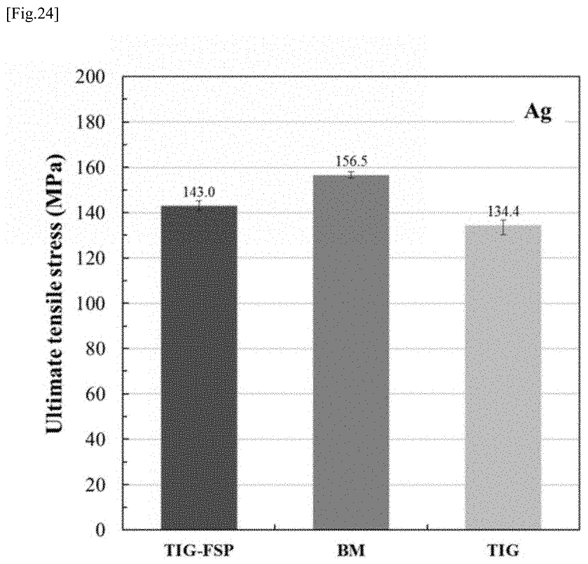

FIG. 24 illustrates a comparison of the maximum tensile strength for Example 2, Reference Example 1, and Comparative Example 1.

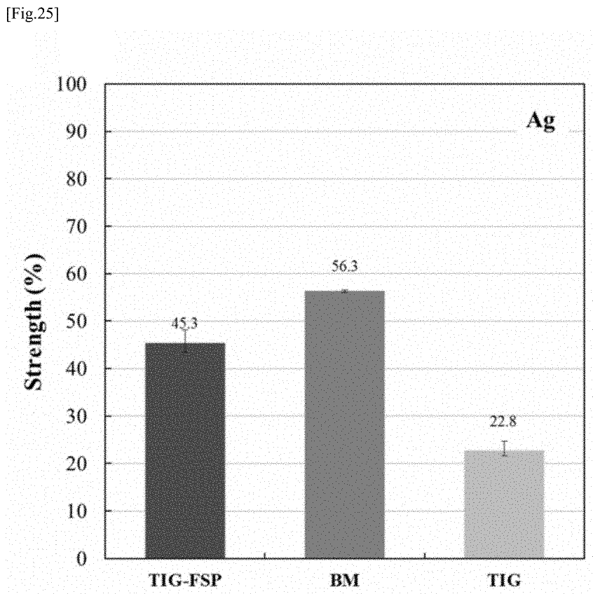

FIG. 25 illustrates a comparison of the elongation rate for Example 2, Reference Example 1, and Comparative Example 1. The elongation rate was calculated by actual measurement of the distance between reference points before and after break.

Compared to Reference Example 1, the maximum tensile strength of Comparative Example 1 was only slightly lower, and the elongation rate was remarkably lower. Meanwhile, compared to Comparative Example 1, the maximum tensile strength and the elongation rate of Example 2 were both higher and close to those of Reference Example 1.

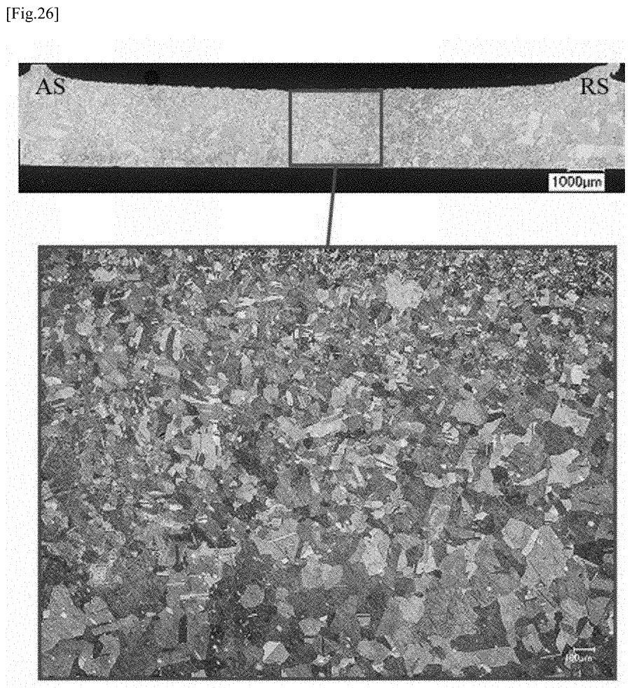

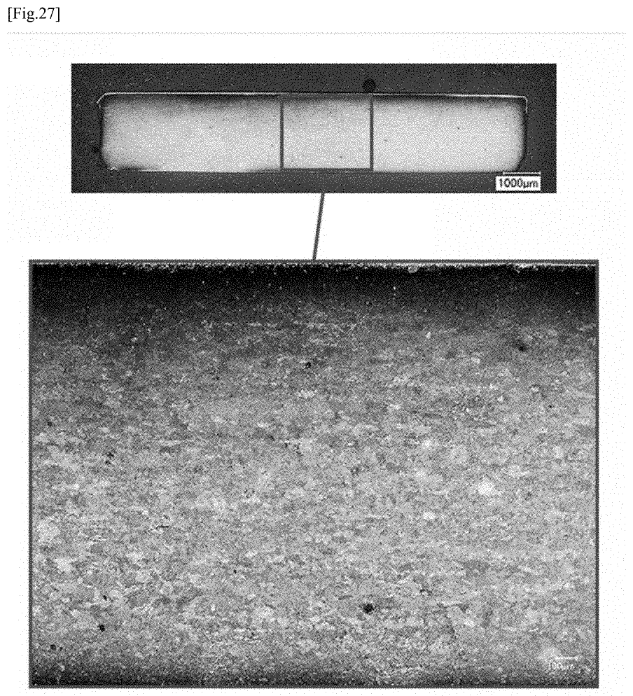

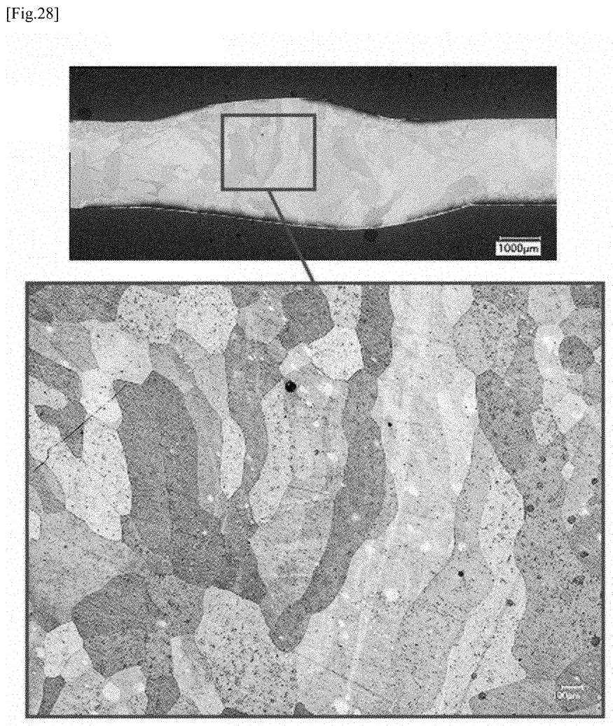

FIG. 26 is a cross-section image and an enlarged image of Example 2. FIG. 27 is a cross-section image and an enlarged image of Reference Example 1. FIG. 28 is a cross-section image and an enlarged image of Comparative Example 1. In FIG. 26, AS indicates the Advancing Side of the friction tool, and RS indicates the Retreating Side of the friction tool.

In the following, the differences in the tensile characteristics shall be discussed on the basis of the cross-section images. In view of the image of FIG. 27, a structure originating from rolling remains, and the crystal grain diameter is minute. On the other hand, FIG. 28 shows a molten structure originating from the TIG welding, and the crystal grain diameter is large. According to the Hall-Petch principle, the strength increases as the crystal grain diameter decreases, and thus it is believed that the difference in crystal grain diameter is influencing the difference in the maximum tensile strength between Reference Example 1 and Comparative Example 1. Furthermore, blow holes are scattered in the grain boundary of the molten structure in FIG. 28, and breakage occurs originating at these blow holes. Thus, it is inferred that the maximum tensile strength and the elongation rate of Comparative Example 1 are reduced compared to Reference Example 1.

In the structure in which repair/modification was carried out in FIG. 26, coarse crystal grains originating from welding are not present, and the crystal grains are small. Further, it can be seen that blow holes, which were probably present at the time of TIG welding, have been eliminated. Thus, it is believed that the structure of Example 2 was similar to the structure and pattern of Reference Example 1, and the maximum tensile strength and elongation rate were equivalent to those of Reference Example 1.

### Comparative Example 2

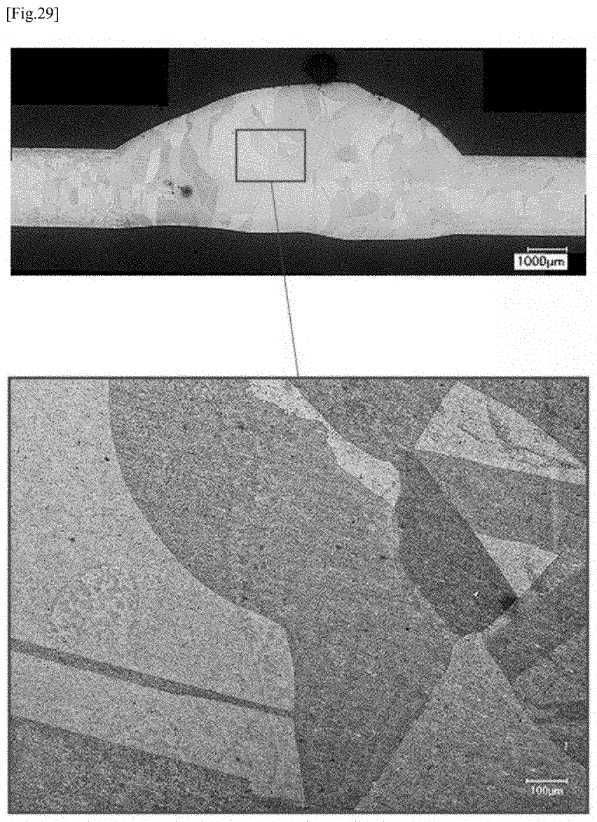

Using a substrate made of pure Ag (purity of 99.99%) and measuring 50 mm×50 mm×2.2 mm in thickness, a friction tool having a probe made of an Ir-based alloy (composition of Ir—Re—Zr) was pressed vertically onto the substrate while being rotated so as to form an end hole having a diameter of 10 mm. FIG. 29 is a cross-section image showing that a pure Ag material was filled into an end hole by TIG. Upon observing the cross-section image showing the entire filled end hole, it was confirmed that the crystal grains were coarsened, and a plurality of blow holes existed.

### Example 3

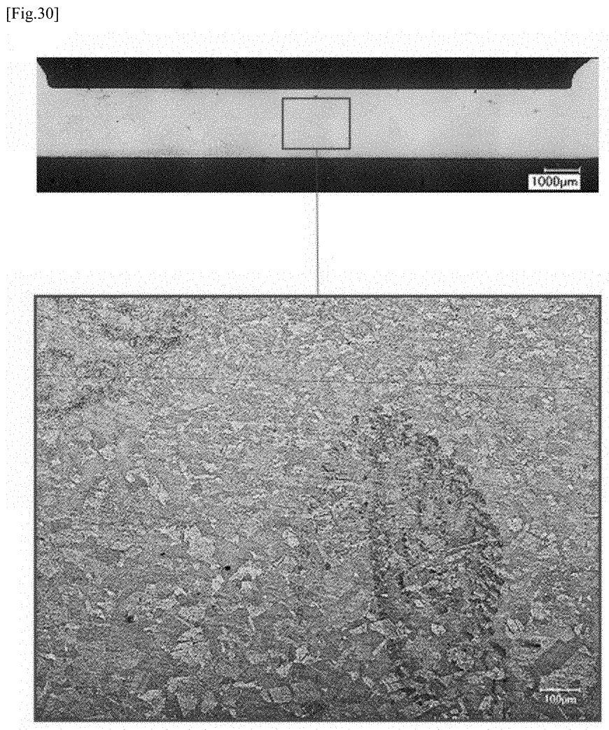

The repair and modification of the substrate shown in FIG. 6 were performed on the location filled with pure Ag of the end hole of the sample of Comparative Example 2, thereby obtaining a sample of Example 3. For the repair/modification, a friction tool that is made of an Ir-based alloy (composition of Ir—Re—Zr), that has a diameter of 15 mm, and that has a distal end with a flat shape was used. Therein, no tilt angle was provided, a silicon nitride plate was used as a backing plate, no shield gas was flowed, the tool rotation speed was 3000 rpm, the tool insertion speed was 6 mm/min, and the tool insertion amount was up to a position at which the distal end part of the friction tool was equivalent to the substrate top surface before the end hole was formed. FIG. 30 shows a cross-section image of the portion that was repaired/modified. Upon observing the cross-section image showing the entire repaired/modified portion, the crystal grains were minute, and no blow holes could be confirmed.

Comparing the results of FIG. 30 with FIG. 29, it is understood that the molten structure originating from TIG was modified, the crystal grains which had a size of 1000 μm or more were micronized to crystal grains of several tens of μm, and blow holes of approximately 100-200 μm were repaired.

### Example 4

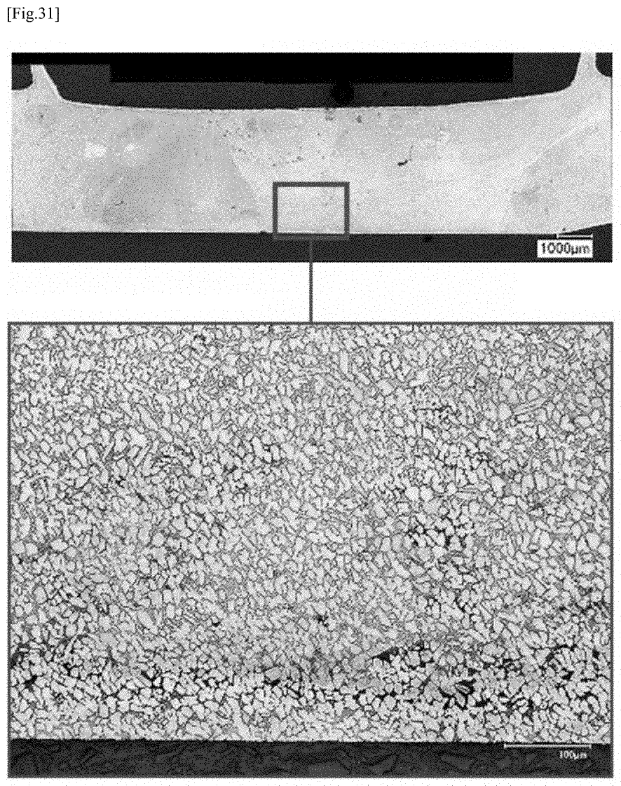

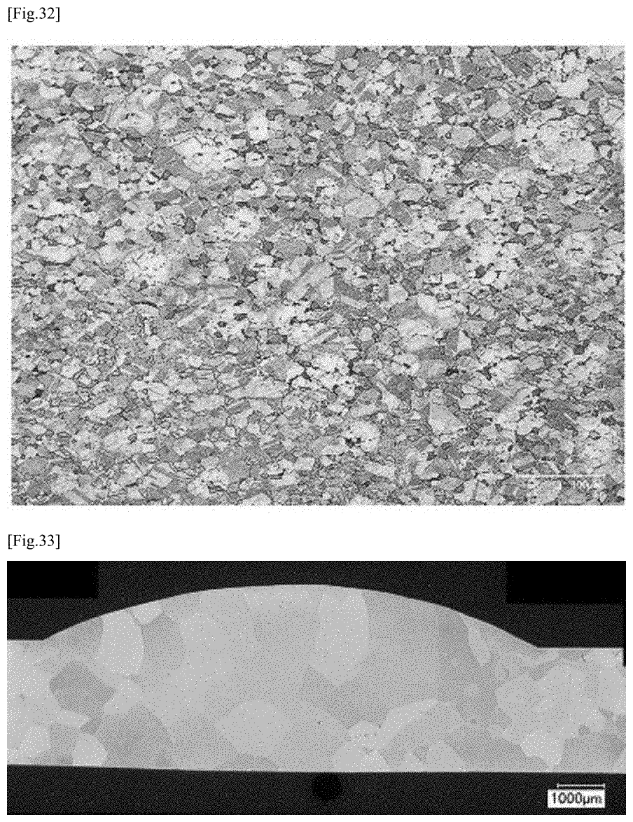

Using a friction tool that is made of an Ir-based alloy (composition of Ir—Re—Zr), that has a diameter of 15 mm, and that has a distal end with a flat shape, a substrate made of a Cu-based alloy (composition of Cu—Zn) and measuring 150 mm×100 mm×4 mm in thickness was repaired/modified, under conditions in which the tilt angle θ was 3°, a silicon nitride plate was used as a backing plate, argon gas serving as a shield gas was flowed at 25 L/min, the tool rotation speed was 1500 rpm, the tool movement speed was 100 mm/min, and the tool insertion amount was 0.4 mm. FIG. 31 is a cross-section image and an enlarged view of the overall repaired/modified portion. The structure directly below the tool was affected by the repair/modification up to a depth of 4 mm, and the size of the crystal grains was fine at about 10 μm as can be seen in the enlarged image in the frame. FIG. 32 shows a cross-section image of a substrate for comparison. Upon observing the substrate cross-section, it was confirmed that the crystal grains were about 50 μm, and thus larger than those of the repaired/modified part.

### Example 5

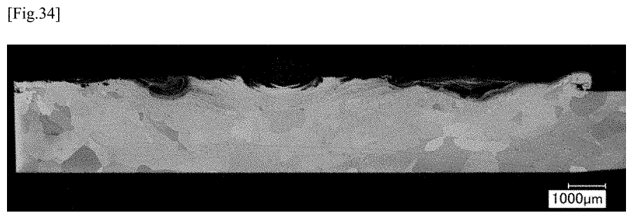

A plate material made of pure Pt (purity of 99.95%) and measuring 50 mm×50 mm×2 mm in thickness was prepared and subjected to overlay welding of pure Pt by TIG, and then repair/modification of the TIG part was conducted by executing the process shown in FIG. 6. For the repair/modification of the TIG part, a friction tool that is made of a hard metal alloy (composition of W—C—Co), that has a diameter of 15 mm, and that has a distal end with a flat shape was used. Therein, no tilt angle was provided, a silicon nitride plate was used as a backing plate, argon gas serving as a shield gas was flowed at 25 L/min, the tool rotation speed was 3000 rpm, the tool insertion speed was 6 mm/min, and the tool insertion amount was up to a position at which the distal end part of the friction tool was equivalent to the substrate top surface before the TIG overlay welding. FIG. 33 is a cross-section image of the TIG overlay welding part. FIG. 34 is a cross-section image of a portion of the TIG overlay welding part that was repaired/modified. In the image of FIG. 33, the crystal grains in the structure of the TIG overlay welding part are nearly equi-axial crystal grains, and the crystal grain diameter is large, averaging about 1000 μm. On the other hand, in the image of FIG. 34, an inverted triangle-shaped region was observed in the repaired/modified part, and it was confirmed that an elongated structure existed in this region, and thus the effects of plastic flow were observed up to a depth of 2 mm directly below the tool. In other words, it was confirmed that the repair/modification was performed over the entire thickness direction of the plate material.

### DESCRIPTION OF REFERENCE SIGNS

1: metallic substrate
2a: first region
2b: second region
3: overlaying
5: friction tool
6: solidification portion at which plastic flow has occurred (solidification portion after formation of a plastic region)
7: motor
8: movement direction of friction tool

What is claimed is:

1. A repair/modification method for metallic substrates, the method comprising:
a step for preparing a metallic substrate that includes a first region that is divided in an in-plane direction of the substrate, the first region containing a defect and/or a structurally discontinuous portion; and
a step for repairing the defect and/or modifying the structurally discontinuous portion by pressing a friction tool which does not have a probe against a top surface of the first region while rotating the friction tool so as to generate frictional heat while pressing on the top surface.

2. The repair/modification method for metallic substrates according to claim 1, wherein the metallic substrate further includes a second region that is divided in the in-plane direction of the substrate, the second region being a portion that does not need to be repaired and/or modified.

3. The repair/modification method for metallic substrates according to claim 1, wherein a portion up to a maximum depth of 20 mm from the top surface of the metallic substrate is repaired and/or modified.

4. The repair/modification method for metallic substrates according to claim 3, wherein the metallic substrate has a thickness exceeding 20 mm, and a portion up to a maximum depth of 20 mm from the top surface of the metallic substrate is repaired and/or modified.

5. The repair/modification method for metallic substrates according to claim 3, wherein the metallic substrate has a thickness of not more than 20 mm, and a portion that is thinner than the entire thickness direction of the metallic substrate or thinner than the substrate thickness from the top surface of the metallic substrate is repaired and/or modified.

6. The repair/modification method for metallic substrates according to claim 1, wherein impurities originating from the friction tool do not become mixed in beyond a depth of 1 mm from the top surface of the portion that was repaired and/or modified.

7. The repair/modification method for metallic substrates according to claim 2, wherein the tensile strength of the substrate including the first region that was repaired and/or modified is 60 to 200% of the tensile strength of the substrate including only the second region.

8. The repair/modification method for metallic substrates according to claim 1, wherein the method further comprises a step for at least partially dissolving the first region before repairing and/or modifying the metallic substrate.

9. The repair/modification method for metallic substrates according to claim 1, wherein the first region of the metallic substrate before repair/modification has a portion that is welded from the top surface to an underside surface.

10. The repair/modification method for metallic substrates according to claim 1, wherein the method further comprises a step for installing or overlaying a material of the same composition as the metallic substrate in at least a portion of the first region of the metallic substrate before repair/modification.

11. The repair/modification method for metallic substrates according to claim 1, wherein in the step for repairing and/or modifying, the friction tool is pressed until a portion that is being pressed by the friction tool undergoes plastic deformation.

12. The repair/modification method for metallic substrates according to claim 1, wherein in the step for repairing and/or modifying, relative movement of the friction tool and the metallic substrate is only in a depth direction of the substrate, only in the in-plane direction of the substrate, or in a direction combining the depth direction of the substrate and the in-plane direction of the substrate.

13. The repair/modification method for metallic substrates according to claim 1, wherein a heat source other than frictional heat is used complementarily before performing the repair and/or modification or when performing the repair and/or modification.

14. The repair/modification method for metallic substrates according to claim 1, wherein the metallic substrate is made of one of Cu, Ag, Au, Pt, a Cu-based alloy, an Ag-based alloy, an Au-based alloy, or a Pt-based alloy.

15. The repair/modification method for metallic substrates according to claim 1, wherein the friction tool is made of one of an Ir-based alloy, an Ni-based alloy, a Co-based alloy, a hard metal alloy, tool steel, or ceramic.

16. The repair/modification method for metallic substrates according to claim 1, wherein the metallic substrate is made of one of Cu, Ag, Au, a Cu-based alloy, an Ag-based alloy, or an Au-based alloy, and the friction tool is made of one of an Ir-based alloy, an Ni-based alloy, a Co-based alloy, a hard metal alloy, tool steel, or ceramic.

17. The repair/modification method for metallic substrates according to claim 1, wherein the metallic substrate is made of Pt or a Pt-based alloy, and the friction tool is made of one of an Ir-based alloy, a hard metal alloy, or ceramic.

18. The repair/modification method for metallic substrates according to claim 1, wherein the metallic substrate constitutes part or all of a liner for a pressure vessel, a capsule for a pressure vessel, a pressure vessel, a sputtering target, or a backing plate for a sputtering target.
